(19) United States
(12) Patent Application Publication
(10) Pub. No.: US 2004/0050797 A1
(43) Pub. Date: Mar. 18, 2004

(54) Scale removal or prevention

(76) Inventors: Anthony Peter Allen, West Yorkshire (GB); Andrea Ruth Gerson, South Australia (AU); Jonas Addai-Mensah, South Australia (AU); Robert Trevor Jones, South Australia (AU); Li Huixin, South Australia (AU); Marek Stanislaw Zbik, South Australia (AU)

Correspondence Address: CIBA SPECIALTY CHEMICALS CORPORATION, PATENT DEPARTMENT, 540 WHITE PLAINS RD, P O BOX 2005, TARRYTOWN, NY, 10591-9005, US

(21) Appl. No.: 10/467,266

(22) PCT Filed: Feb. 4, 2002
(86) PCT No.: PCT/EP02/01112

(30) Foreign Application Priority Data
Feb. 9, 2001 (GB) 0103192.1

(51) Int. Cl. C02F 1/52

(52) U.S. Cl. 210/729

(57) ABSTRACT

A method of reducing scaling in an alkaline treatment liquor circuit in a metal ore treatment process, in which metal ore is digested in an alkaline medium in a digestion stage to form a suspension of ore residue solids in an aqueous liquor containing metal values, separating the solids from the liquor in a separation stage and then transferring the aqueous liquor containing metal values to a metal values recovery circuit from which the metal values are precipitated and separated from the alkaline liquor, wherein scaling of the surfaces is reduced by introducing into the alkaline liquor an effective amount of polymeric scale suppressant, characterised in that the polymeric suppressant comprises an ammonium or alkali metal salt of a polymer having an average molecular weight below 50,000 and which is a copolymer comprising 30 to 99 weight % ethylenically unsaturated carboxylic acid moieties and 1 to 70 weight % isobutyl (meth) acrylate moieties.

The present invention concerns reducing scaling in an alkaline treatment liquor circuit in a metal ore treatment process, in which metal ore is digested in an alkaline medium in a digestion stage to form a suspension of ore residue solids in an aqueous liquor containing metal values, separating the solids from the liquor in a separation stage and then transferring the aqueous liquor containing metal values to a metal values recovery circuit from which the metal values are precipitated and separated from the alkaline liquor. In particular the invention relates to reducing scaling in a Bayer alumina process, especially in regard to the fouling of Bayer process heat exchangers.

It is known that scale deposition can be a problem in processing of metal ores using alkaline treatments and in the recovery of metal values from the liquors produced therefrom. For instance water-soluble polymers of ethylenically unsaturated monomers containing acid groups selected from carboxylic and sulphonic acid groups are described for use in scale prevention in the alkaline cyanide treatment circuit of a gold ore extraction process in U.S. Pat. No. 5,547,647.

Scale formation can be a particular problem in the Bayer alumina process. The high temperatures and caustic concentrations required for digestion of bauxite ores result in the concomitant dissolution of silicate minerals, such as kaolin and quartz, that are also present in the ore. Silica solubility increases with increasing alumina concentration, so precipitation of the gibbsite (Al(OH)₃), results in a liquor that is supersaturated in silica. This can lead to crystallisation of sodium aluminosilicates, which form a scale on the inside of the heat exchangers. Scaling reduces the efficiency of the heat exchangers and so steam must be injected directly into the liquor to obtain the temperatures required for bauxite digestion.

If scaling is allowed to continue unchecked the heat exchangers eventually become blocked. Consequently, parallel circuits have to be constructed to allow continuous operation of the plant while heat exchangers are taken off-line for cleaning. The use of acid to clean heat exchangers, along with other maintenance costs, increases the losses incurred by scale formation.

Various scale treatment procedures have been proposed. For instance it is known to introduce water soluble polymeric antiscalents, which are formed entirely from water soluble monomers and mainly from monomers containing acid groups. Homopolymers of acrylic acid or maleic acid or water soluble salts thereof have been used in order to remediate the effects of scale deposition in these situations.

Polymers such as polyacrylic acid and polymaleic acid are often used as scale inhibitors, or as a component in a scale inhibitor in various processes, for instance boiler water scale treatment. Examples are in EP 538,026 (which is concerned primarily with calcium sulphate scale) and U.S. Pat. Nos. 4,640,793, 5,080,801 and 5,156,744 which are concerned with various mineral processing and other industrial processes, in which there will be a diversity of chemical types of scale. The scale inhibition treatment often involves the use of a mixture of compounds, for instance the polyacrylic acid or polymaleic acid polymers mentioned above in combination with sequestering agents or other materials. Similarly WO-A-00/73218 describes copolymers of (meth) acrylic acid and maleic acid and/or maleic anhydride as inhibitors of calcium oxalate coatings.

GB-A-2087862 discloses copolymers that act as a dispersant in hard water systems without adversely affecting scale inhibition. The copolymers are of acrylic acid or maleic acid with comonomers selected from (meth)acrylamide, 2-hydroxyethyl (meth) acrylate, 2-hydroxy propyl (meth) acrylate, methyl (meth) acrylate, ethyl (meth) acrylate, (meth) acrylonitrile, vinyl alcohol and 2-methyl vinyl alcohol. These polymers are not said to have any advantageous antiscaling benefits only that they are not disadvantageous to antiscaling.

The preparation of low molecular weight polymers for use as detergent additives, scale inhibitors, dispersants and crystal growth modifiers is given in EP-A-590842. The polymers comprise monocarboxylic acids, such as acrylic acid, dicarboxylic acids, such as maleic acid and optionally other monomers. The optional other monomers are said to be any monoethylenically unsaturated carboxyl free monomers, and isobutyl methacrylate is included in a long list of possible monomers including various alkyl esters of acrylic or methacrylic acid and various other styrenic, acrylic, vinylic or allylic monomers.

Similar disclosures of processes for preparation of such low molecular weight polymers are given in EP-A-676422 and EP-A-398724.

U.S. Pat. No. 5,080,801 describes a method of preventing and inhibiting scale on solid surfaces in contact with mineral processing-waters by using a composition containing blends of a first component polyacrylic acid and a second component which is a copolymer of acrylic acid and C₁₋₆ alkyl acrylate. Most preferably the composition contains 1 to 10% of a third component which is a terpolymer which contains acrylic acid, alkyl sulphonate substituted acrylamide and acrylamide. The preferred copolymers are copolymers of acrylic acid with either methyl acrylate or ethyl acrylate. A variety of mineral processing applications are referred to, including recovery of precious metals and copper, coal preparation, phosphoric acid production and alumina production from bauxite.

GB-A-1505909 describes the treatment of water to prevent scale in cooling or boiler water industrial systems using bisulphite terminated oligomers comprising acrylic acid with either acrylonitrile or methyl acrylate.

In the processes involving processing of metal ore and extraction of metal values in highly alkaline environments and especially at high temperatures, many known antiscalents are not sufficiently effective. Thus there is a need for an improved scale treatment method for these processes. In particular there is a need for a treatment that will prevent scaling in Bayer alumina processes and especially in preventing the fouling of heat exchangers in the Bayer alumina process.

According to the present invention we provide a method of reducing scaling in an alkaline treatment liquor circuit in a metal ore treatment process, in which metal ore is digested in an alkaline medium in a digestion stage to form a suspension of ore residue solids in an aqueous liquor containing metal values, separating the solids from the liquor in a separation stage and then transferring the aqueous liquor containing metal values to a metal values recovery circuit from which the metal values are precipitated and separated from the alkaline liquor, wherein scaling of the surfaces is reduced by introducing into the alkaline liquor an effective amount of polymeric scale suppressant,

characterised in that the polymeric suppressant comprises an ammonium or alkali metal salt of a polymer having an average molecular weight below 50,000 and which is a copolymer comprising 30 to 99 weight % ethylenically unsaturated carboxylic acid moieties and 1 to 70 weight % isobutyl (meth) acrylate moieties.

We have found that copolymers which-comprise isobutyl (meth) acrylic ester components reduce scale coverage on metal surfaces in the processing plants. The benefits of scale reduction have been found when employing polymers which comprise between 1 and 70 weight % of the isobutyl (meth) acrylate components. In particular we have found particular benefits in preventing scale in the Bayer alumina process.

Scale forming reactions are believed to involve physicochemical interactions facilitated by a high surface energy of steel surfaces of the process plant. Previous work has shown that the deposition of sodalite/cancrinite scale at hot steel surfaces from optically-clear alkaline liquors occurs by substrate-mediated precipitation fouling. Thus direct heterogeneous nucleation and growth of scale at the liquor-steel interface appears to be the mechanism as opposed to homogeneous nucleation in the bulk solution followed by particulate deposition.

The dimorphic phase change occurs through simultaneous, first order dissolution of sodalite and nucleation of cancrinite. The kinetics of this process are believed to be dominated by a high activation energy-temperature effect. Furthermore, as silica is the limiting reactant, the kinetics of desilication is a strong function of silica supersaturation.

Without being limited to theory, it is believed that in the invention the interactions between the polymer functional groups and the alumino silicate scale forming constituents possibly altered the interfacial energy of the critical cluster/nuclei in solution such that only a smaller fraction of embryos of larger sizes survived and nucleated. Thus the antiscalent polymers of the present invention interfere with the normal mechanisms of scale deposition is such a way that scale coverage on the surfaces is minimised. Furthermore, scale deposition that does occur tends to be onto existing scale deposits rather than the metal surface. The effects of this would be a reduction in the overall scale coverage of metal surfaces, for instance the heat exchangers. Thus since a greater proportion of the heat exchanger surface will be exposed to the liquor the heat transfer performance is less likely to be impaired.

Thus we have found that by inducing heterogeneous nucleation of scale the heat exchangers in the Bayer alumina process are less prone to fouling by scaling, since scale surface coverage is minimised and therefore heat transfer performance is not or insignificantly impaired.

Typically the polymeric antiscalent of the present invention can be introduced into the alkaline liquor at any stage in the process. The dose should be an amount sufficient to bring about a reduction in scaling of surfaces, especially minimising the overall scale cover of the metal surfaces. Desirably the amount of antiscalent is between 50 and 10,000 ppm, based on weight of additive by volume of liquor. Preferably a suitable dose would be 100 to 2,000 or 3,000 ppm, especially in the range 250 to 1,500 ppm. A particularly effective dose is typically around 300 ppm. The antiscalent polymer of the present invention may contain as little as 1 weight % of the ethylenically unsaturated carboxylic acid moiety, although desirably it may be preferred for the ester moiety to be present in higher amounts, for instance 10, 15, 20 or even 30%. Preferably the polymer consists of from 60 to 90 weight % of the acid moieties and 10 to 40 weight % of the ester moieties.

The preferred carboxylic acid monomers are either acrylic acid or methacrylic acid, although in some instances it may be desirable to use maleic acid. Preferably the monomeric ester is an acrylic or methacrylic ester. More preferred are n-butyl, isobutyl or tertbutyl acrylates. The preferred antiscalent is a copolymer of 60 to 85 weight %, preferably about 70 weight %, acrylic or methacrylic acid with the balance being isobutyl methacrylate. For instance the polymer may be formed from 65 to 75 weight %, often 68 to 73 weight %, acrylic acid and 25 to 35% (often 27 to 32%) isobutyl methacrylate.

The butyl groups present in the antiscalent of the invention are usually selected from n-butyl, tert-butyl or isobutyl, isobutyl often being preferred. Accordingly a preferred polymer is formed from 75 to 85 weight % (meth) acrylic acid and 15 to 25 weight % isoutyl methacrylate. Especially preferred is a copolymer of about 70 weight % acrylic or methacrylic acid and about 30 weight % isobutyl methacrylate.

The polymeric antiscalent must have a suitably low molecular weight, such that it functions as an effective antiscalent and so the molecular weight should be below 50,000. Desirably, however, the polymer is usually lower molecular weight, for instance below 20,000, preferably below 10,000. Normally it is at least 1,000, and often it is in the range 1,500 to 7,500, especially around 4,000 to 6,500. Especially preferred are polymers of molecular weight in the range 4,500 to 6,000, for instance around 5,000 or 5,500.

The polymer is generally made by solution polymerisation in isopropanol in the presence of an appropriate initiator such as ammonium persulphate, in a manner conventional for the manufacture of low molecular weight polycarboxylic acid dispersants or antiscalents. The polymerisation is conveniently conducted while the acidic groups are in the form of free acid although the groups can be wholly or partially neutralised to form a water soluble salt, for instance with alkali metal or amine or ammonia if desired.

Usually the polymer is used in partially or, more usually, substantially fully neutralised form, wherein X is alkali metal (usually sodium or potassium), ammonium or amine. The preferred forms are the sodium and ammonium forms.

The following examples illustrate the invention.

### EXAMPLE 1

Preparation of Polymer A

parts by weight of isobutyl methacrylate were mixed with 70 parts by weight of acrylic acid and added over a period of 2.75 hours to refluxing isopropanol. Ammonium persulphate (initiator), in an amount of 2% by weight based on weight of monomer, and thioglycolic acid (chain transfer agent) in an amount of 5% by weight of monomer are added to the reaction mixture over 2.75 hours. After the polymerisation was complete, the isopropanol was distilled off and the copolymer was neutralised with sodium hydroxide to pH 7. The resultant copolymer was a copolymer of 30 weight % isobutyl methacrylate and 70 weight % acrylic acid as sodium salt and the polymer had an average molecular weight of the order of 5,700.

### EXAMPLE 2

In test 1 isothermal, synthetic spent Bayer liquor precipitations were performed at 180° C. and about 800 kPa, reflecting the conditions in alumina heat exchangers. The following chemicals, experimental procedures and analytical techniques were employed. Synthetic, spent Bayer liquors with initial concentration of 0.01 M SiO₂ (0.6 g dm⁻³), 1.67 M Al(OH)₃ (128.5 g dm⁻³), 3.87 M NaOH (154.8 g dm⁻³) and 0.38 M Na₂CO₃(40 g dm⁻³) were used. The liquors were prepared by dissolving known masses of gibbsite (γ-Al(OH)₃—C31, ALCOA, USA), sodium carbonate (99.9%, Merck, Australia), sodium metasilicate (27.8-29.2% SiO₂, 28.1% Na₂O, 4243% H₂O, Merck, Australia) and NaOH (97.5%, 2.5% Na₂CO₃, Merck, Australia) in Milli-Q water (specific conductivity less than 0.5 μS cm⁻¹)

The batch crystalliser was a 0.6 dm³ stirred, stainless steel autoclave (Parr instruments, USA). An agitation rate of 400 rpm was used. Scale deposition on untreated 316-stainless steel substrates, with surface asperities ranging from-22(2 to 15×15 μm in size and peak to base heights up to 5 μm, was studied. The steel substrates (three 2×0.5 cm) were attached to the shaft of the impeller at 90° pitch to act as blades. Each experimental run lasted for 4 hours. All substrates and scale precipitation products were characterised by scanning electron microscopy (SEM) and energy dispensive spectroscopy (EDAX) (15 kV on carbon coated samples by using a high resolution field emission Camscan CS44FF (Cambridge, UK). X-ray diffraction (XRD) (Phillips PWI 130/90) patterns were collected on powdered samples in θ/2θ scanning mode using CuKα radiation (λ=1.5418 Å). The scan speed was 1° per min between 10° and 70° 2θ. Specific surface area of solid samples was analysed by N₂BET analysis (Coulter Omnisorp 100). Additional mineralogical composition analyses were carried out by x-ray fluorescence spectroscopy (XRF) and differential thermal analysis (TA Instruments, USA). Solution SiO₂, Al³⁺ and Na⁺ ion concentrations were analysed by inductively coupled plasma spectroscopy (ICP, Spectro SIM-SEQ ICP-OES, Germany). Optical clarity/turbidity of all solutions were checked and confirmed by static light scattering (Brice Phoenix Photometer).

Polymer A was added in an amount of 300 mg/dm³ to the synthetic Bayer liquor. STIMAN (STructure IMage ANalysis, Moscow State University) image processing statistical package was used for quantification of the scale particle features and coverage on steel substrate.

The steel substrate was exposed to the Bayer liquor for 4 hours at 180° C. and a constant concentration of polymer A of 300 mg/dm³ was maintained.

Test 2 is a repeat of test 1 but without adding antiscalent polymer A.

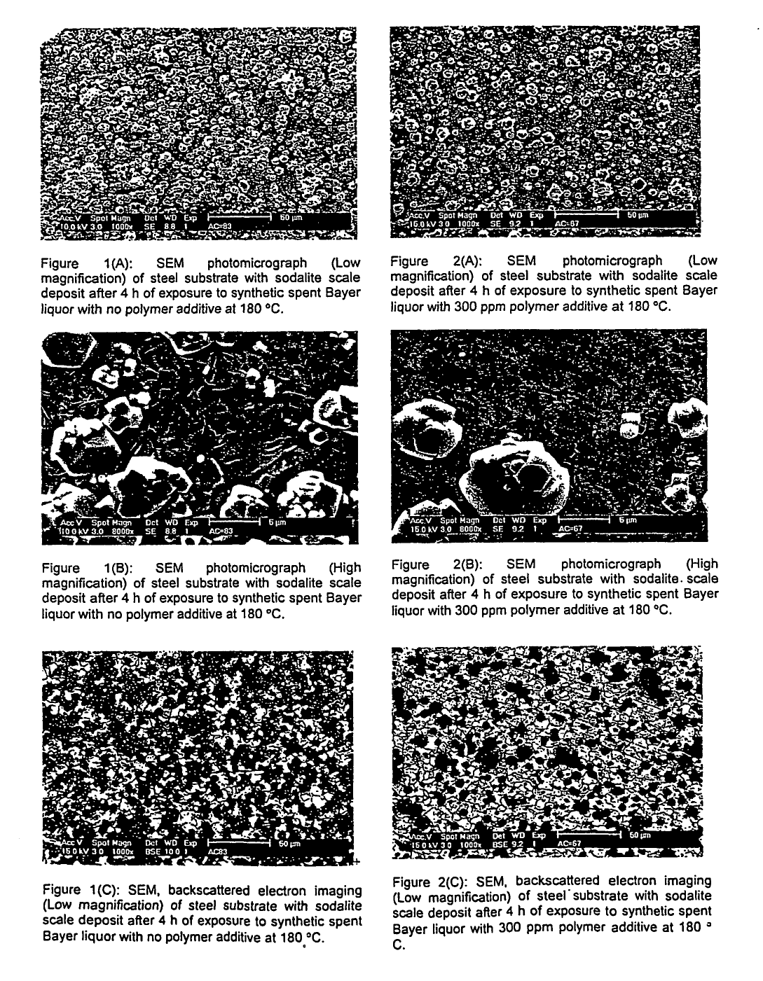

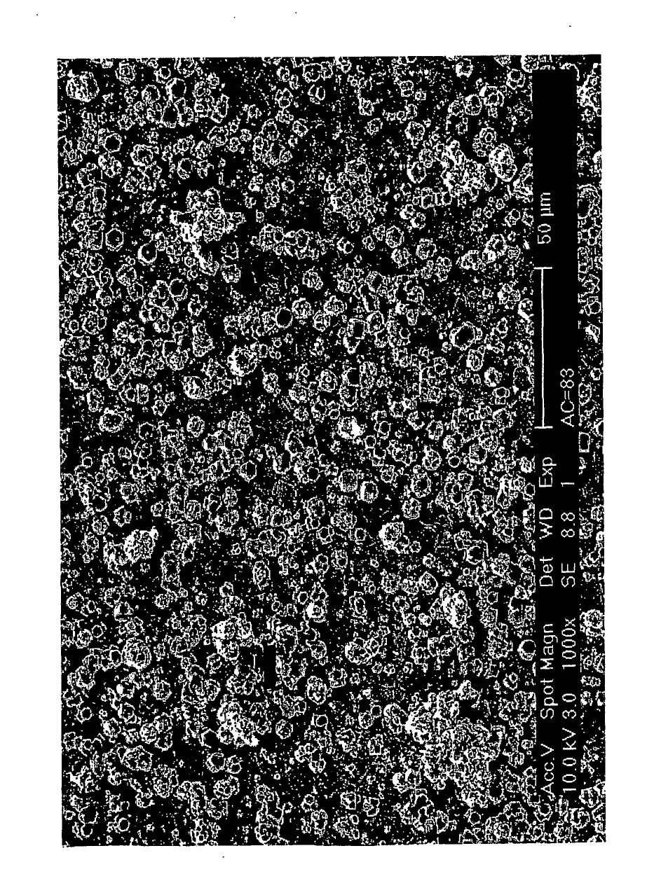

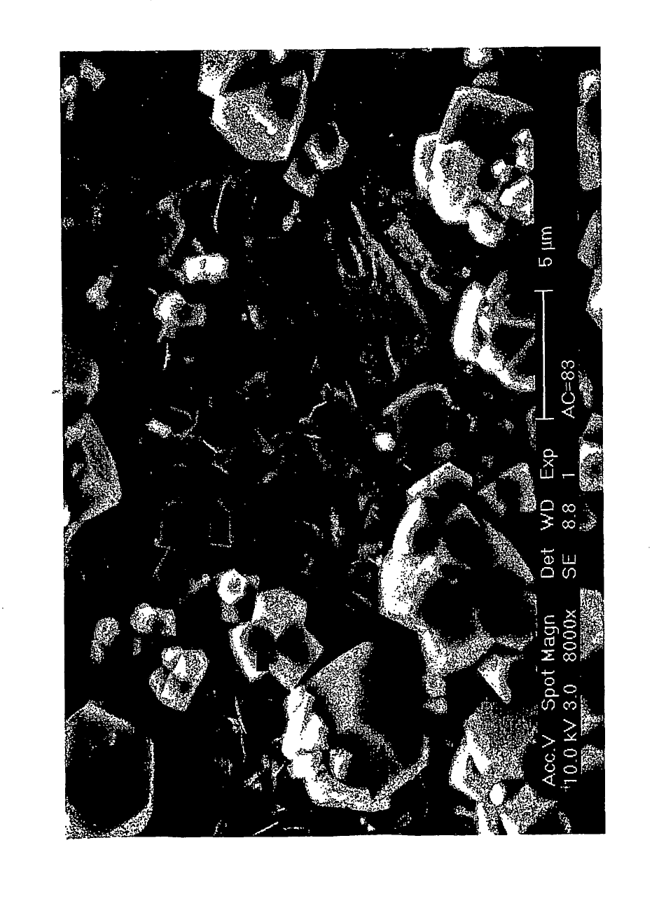

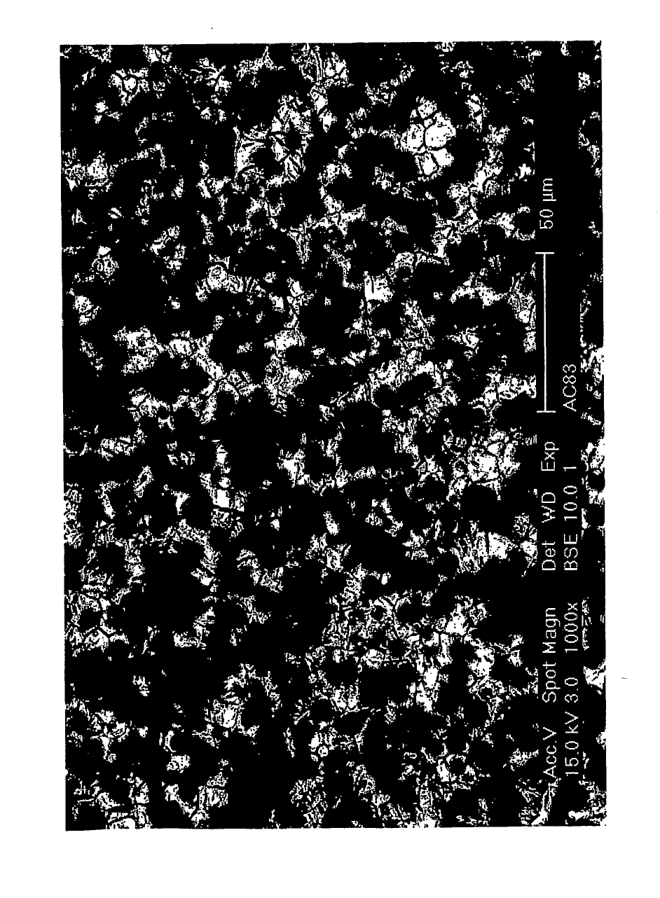

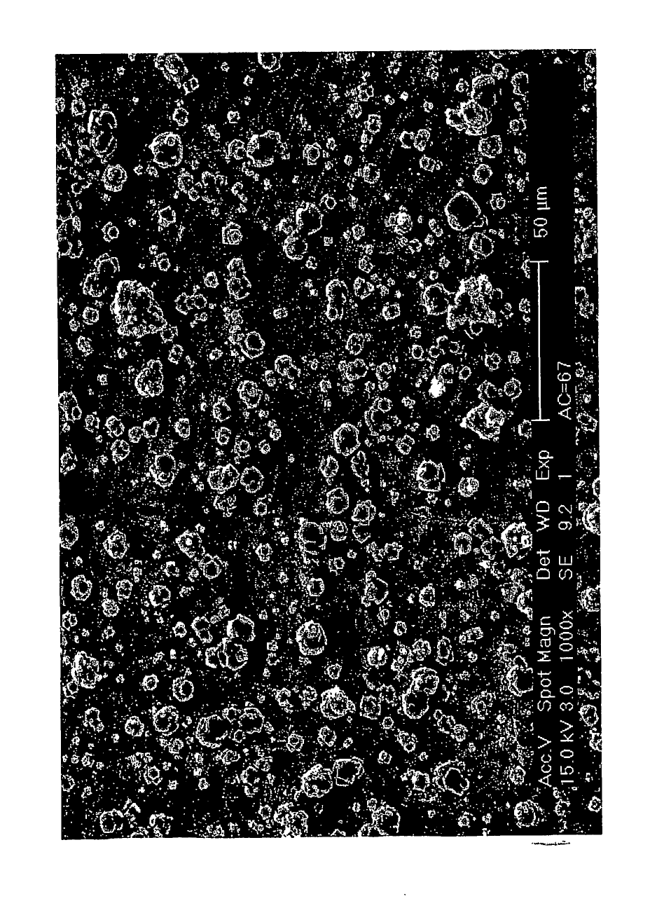

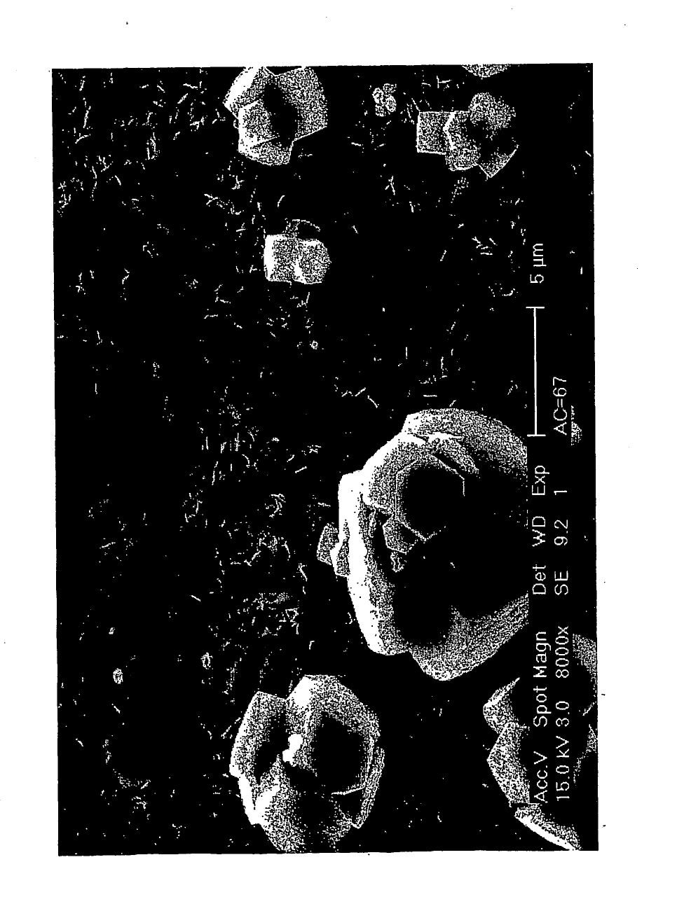

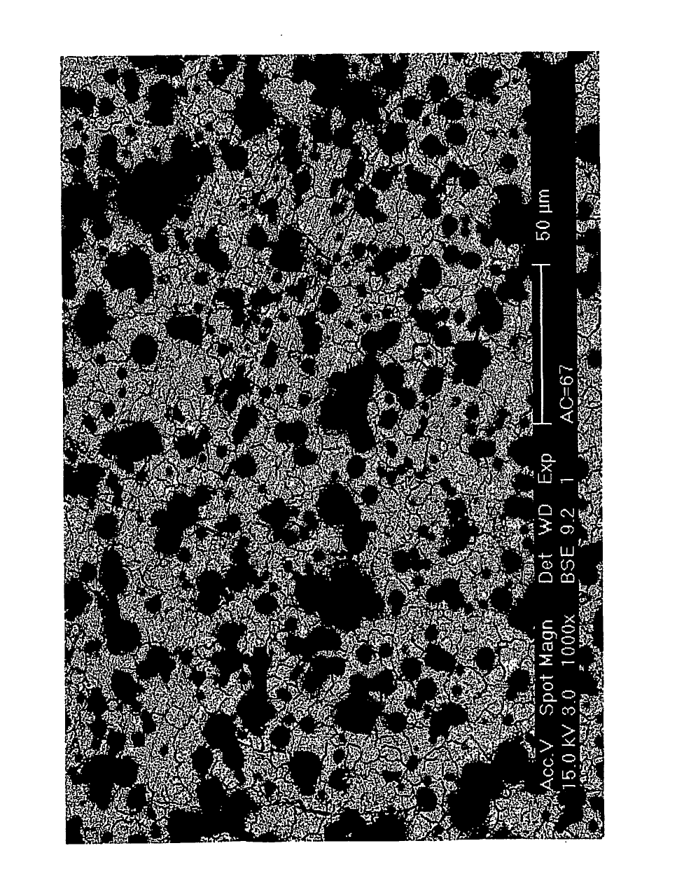

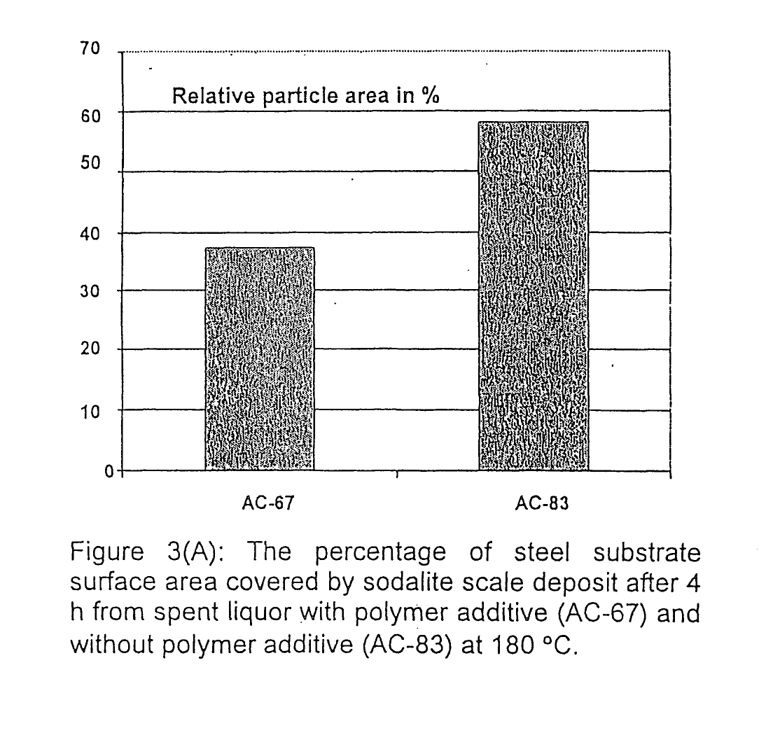

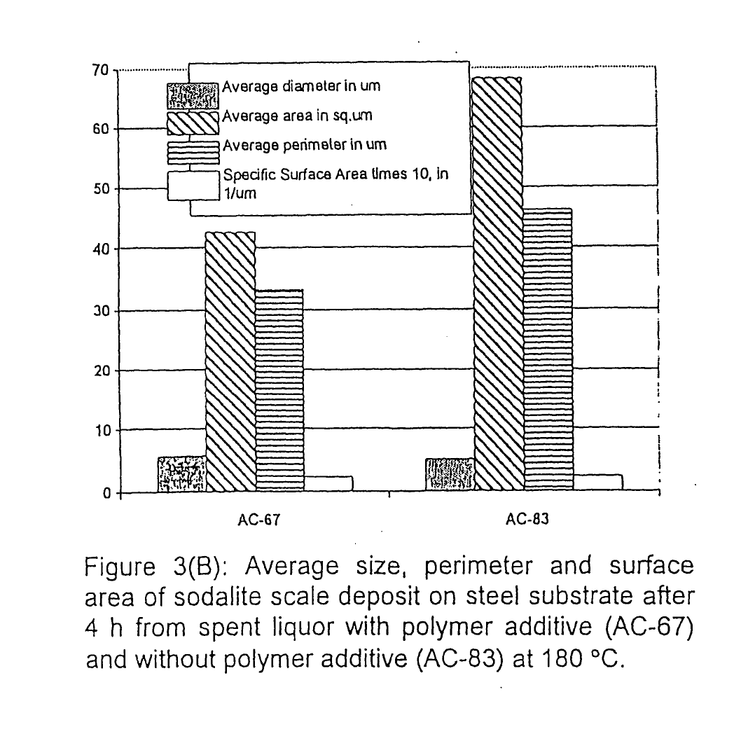

Typical SEM (Scanning Electron Micrograph) photomicrographs of the steel substrates for both tests are shown in FIG. 1 (A, B and C) (Test 2) and FIG. 2 (A, B and C) (Test 1). FIGS. 1 (A and B) and 2 (A and B) display secondary electron imaging results, showing details of the extent of proliferation of the deposited scale crystal, sizes and morphology at the steel substrate surface. FIGS. 1(C) and 2(C) are the back scattered (BSE) images of the same fouled substrates, indicating the areas covered by scale as dark and the background steel substrate as-grey. The BSE images were used in conjunction with the STIMAN program to statistically quantify the scale coverage characteristics (FIG. 3(A and B)).

The result of scale coverage and average particle size analysis clearly showed polymer additive dependency. The total number of-primary particles per square micron decreased whilst the average crystal size increased from about 5 to 6 microns on addition of polymer A, resulting in an overall decrease in total scale area coverage. Furthermore, the additive had no noticeable effect on crystal habit morphology.

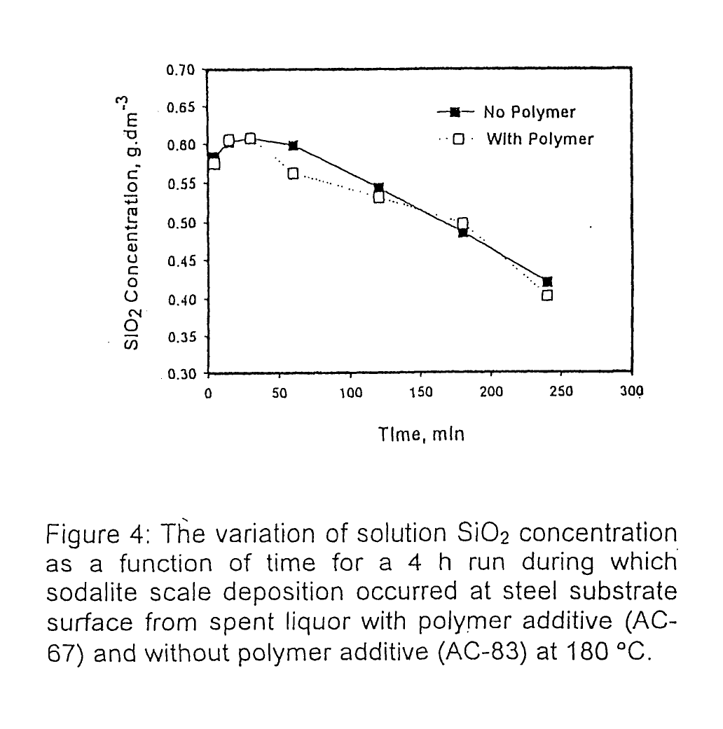

In the absence of the polymer additive (Polymer A), about 60% steel substrate total area coverage was typically observed but decreased to about 40% in the presence of polymer (FIG. 3(A)). The significant reduction in scale deposition is further exemplified by the data in (FIG. 3(B)). XRD analysis indicated that the scale product obtained both in the presence and absence of the polymer additive was high in CO₃²⁻-sodalite. The liquor SiO₂ concentration with and without polymer A showed a similar variation with time (FIG. 4), indicating that the total mass of desilication products precipitated were substantially the same.

1. A method of reducing scaling in an alkaline treatment liquor circuit in a metal ore treatment process, in which metal ore is digested in an alkaline medium in a digestion stage to form a suspension of ore residue solids in an aqueous liquor containing metal values, separating the solids from the liquor in a separation stage and then transferring the aqueous liquor containing metal values to a metal values recovery circuit from which the metal values are precipitated and separated from the alkaline liquor,
wherein scaling of the surfaces is reduced by introducing into the alkaline liquor an effective amount of polymeric scale suppressant,
characterised in that the polymeric suppressant comprises an ammonium or alkali metal salt of a polymer having an average molecular weight below 50,000 and which is a copolymer comprising 30 to 99 weight % ethylenically unsaturated carboxylic acid moieties and 1 to 70 weight % isobutyl (meth) acrylate moieties.

2. A method according to claim 1 in which the polymeric suppressant consists of the copolymer of ethylenically unsaturated carboxylic acid and isobutyl (meth)acrylate.

3. A method according to claim 1 or claim 2 in which the ethylenically unsaturated carboxylic acid is selected from (meth) acrylic acid.

4. A method according to any of claims 1 to 3 in which the copolymer comprises 60 to 85 weight % (meth) acrylic acid (or ammonium or metal salt thereof and 15 to 40 weight % isobutyl methacrylate moieties.

5. A method according to any of claims 1 to 4 in which the copolymer comprises 75 to 85 weight % (meth) acrylic acid (or ammonium or alkali metal salt thereof) and 15 to 25 weight % isobutyl methacrylate.

6. A method according to any of claims 1 to 5 in which the polymer consists of (meth) acrylic acid moieties and isobutyl methacrylate moieties.

7. A method according to any one-of-claims 1 to 6 in which the polymer has a molecular weight below 20,000, preferably below 10,000.

8. A method according to any of claims 1 to 7 in which the metal ore treatment process is a Bayer alumina process.

9. A method according to any one of claims 1 to 8 in which the amount of polymeric scale suppressant is between 50 and 10,000 ppm, based on weight of additive by volume of liquor.

10. A method according to claim 9 in which the amount of polymeric scale suppressant is between 100 and 3,000 ppm.

11. A method according to any of claims 1 to 10 in which the alkaline liquor is in contact with one or more metal surface(s) and in which the presence of the polymeric scale suppressant in the liquor induces any-scaling to occur preferentially on sites of existing scale deposition, thereby resulting in a reduction of overall scale cover on the metal surface(s).
